(19) United States
(12) Patent Application Publication
(10) Pub. No.: US 2015/0130621 A1
(43) Pub. Date: May 14, 2015

(54) Remotely Installed Fires & Smoke Detector

(71) Applicant: Ronald F. Seiler, North Fort Myers, FL (US)

(72) Inventor: Ronald F. Seiler, North Fort Myers, FL (US)

(21) Appl. No.: 14/600,890

(22) Filed: Jan. 20, 2015

Related U.S. Application Data
(63) Continuation-in-part of application No. 13/998,315, filed on Oct. 21, 2013.

(51) Int. Cl. G08B 17/10; H01M 2/10

(52) U.S. Cl. CPC G08B 17/10; H01M 2/10
USPC 340/628; 29/623.1

(57) ABSTRACT

This invention comprises a fire and smoke detector and alarm device comprising a base unit which is recess-mounted into a surface and has at least three female connectors connected with basic wiring attached to each female connector; a battery quick connect locking a battery into the base unit when the battery is pushed into said battery quick connect by a first push; a bottom unit which is removably attached to the base unit using a hand manipulated pole; at least one detector for detecting a prescribed condition in an airstream, the at least one detector connected to the basic wiring; and at least one alarm for projecting a sound when the at least one detector detects the prescribed condition in the airstream, the alarm also connected to the basic wiring; wherein when the battery is locked into said battery quick connect via a first push, said battery provides a power source for the basic wiring; the battery disengages from the battery quick connect via a second push for removal of the battery, said removal terminates of the power source for the basic wiring.

### CROSS-REFERENCE TO RELATED APPLICATION

This application is a continuation-in-part (CIP) of U.S. Non-Provisional patent application Ser. No. 13/998,315 filed Oct. 21, 2013, which is incorporated by reference herein.

### FIELD OF THE INVENTION

The invention relates to a quick connect battery element of a fire and smoke detector and alarm, where the fire and smoke detector and alarm is inset into a surface.

### BACKGROUND OF THE INVENTION

Fire and smoke alarm detectors are normally installed by climbing a ladder and make the necessary wire connections to existing wires that are contained in an electrical box mounted in the ceiling. Generally, a battery needs to be attached to the wire connections within the ceiling mounted electrical box using at least one hand or two hands of a user. There is normally a base element which is mounted on the ceiling in front of the electrical box. Once the necessary wire connections are made, the detecting unit is mounted over the base element by way of screws.

### BRIEF SUMMARY OF THE INVENTION

It is, therefore, an object of the present invention to provide a fire and smoke detector and alarm. It is another object of the present invention to provide a method of using said fire and smoke detector and alarm.

An exemplary environment for the present invention can include, but is not limited to, a structure, such as a residential abode or a commercial facility or any other structure where a fire and smoke detector and alarm in functionally necessary.

In an exemplary embodiment of the present invention, a fire and smoke detector and alarm can include a base unit, a battery quick connect, a bottom unit, at least one detector, and at least one alarm.

In an exemplary aspect of the present embodiment, the base unit can be recess-mounted into a surface, and can have at least three female connectors connected with a basic wiring attached to each of said female connectors.

In another exemplary aspect of the present embodiment, the battery quick connect can lock a battery into the base unit when the battery is pushed into said battery quick connect by a first push.

In a further exemplary aspect of the present embodiment, the bottom unit can be removably attached to the base unit using a hand manipulated pole.

In yet another exemplary aspect of the present embodiment, the least one detector can detect a prescribed condition in an airstream. Also, the at least one detector can be connected to the basic wiring.

In yet still a further exemplary aspect of the present embodiment, the at least one alarm can project a sound when the at least one detector detects the prescribed condition in the airstream. Also, the at least one alarm can be connected to the basic wiring.

In yet again another exemplary aspect of the present embodiment, when the battery is locked into the battery quick connect, the battery provides a power source for the basic wiring. Also, the battery disengages from the battery quick connect via a second push for removal of the battery, and this removal terminates of the power source for the basic wiring.

The following are additional and/or exemplary aspects of this exemplary embodiment, one or more of which can be combined with the basic invention as embodied above:
the hand manipulated pole has an upper end with a cap having outwardly extending prongs thereon and said prongs engage at least one peripheral depression on said base unit;
the bottom unit has male connectors thereon which engage said female connectors by way of rotation of said bottom unit;
the battery quick connect has at least one flange which acts as a fastener to immobilize the battery when a first push forces the battery into said battery quick connect, and acts as a release when a second push disengages the battery from said battery quick connect;
the battery quick connect has more than one flange which acts as a fastener to immobilize the battery when a first push forces the battery into said battery quick connect, and acts as a release when a second push disengages the battery from said battery quick connect; and
the battery quick connect is connected an external wiring configuration which attaches said fire and smoke detector and alarm device to a general wiring of a structure in which the surface into which the base unit is recess-mounted, wherein said external wiring configuration allows for a backup power source for said fire and smoke detector and alarm device.

One exemplary method of inserting and removing a battery into a battery quick connect of the present invention may comprise:
pushing a battery with a first push into the exposed at least one flange of a battery quick connect, the at least one flange acting as a fastener to immobilize the battery in the battery quick connect; and
pushing a battery with a second push into the exposed at least one flange of the battery quick connect, the at least one flange acting as a release when the second push disengages the battery from said battery quick connect;
wherein immobilization of the battery in the battery quick connect results in connection with a basic wiring configuration and provides a power source for this basic wiring and wherein release of the battery from the quick connect results in removal of the connection with the basic wiring connection and termination of the power source for this basic wiring.

The following are additional and/or exemplary aspects of this exemplary method, one or more of which can be combined with the basic method as embodied above:
the battery quick connect has more than one flange which acts as a fastener to immobilize the battery when a first push forces the battery into the battery quick connect, and acts as a release when a second push disengages the battery from the battery quick connect;
the battery quick connect is connected an external wiring configuration which attaches the fire and smoke detector and alarm device to a general wiring of a structure in which the surface into which the base unit is recess-mounted, wherein the external wiring configuration allows for a backup power source for the fire and smoke detector and alarm device and
each element of said fire and smoke detector and alarm device is serviced by maintaining each element, repairing each element, replacing each element or modifying each element in whole or in part.

These and other exemplary aspects of the present invention are described herein.

Those skilled in the art will recognize still other aspects of the present invention upon reading and understanding the attached description

### BRIEF DESCRIPTION OF THE DRAWINGS

The present invention is illustrated by way of example, and not in limitation, in the figures of the accompanying drawings.

FIG. 1 illustrates one exemplary embodiment of an inset portion of the basic unit with a battery quick connect feature and also a cover portion which attaches to the inset portion.

FIG. 2 illustrates one exemplary embodiment of a battery quick connect feature, base unit not shown.

FIG. 3 is a flow chart illustrating a method of attaching a battery in a quick connect feature of the inventive fire and smoke detector.

### DETAILED DESCRIPTION OF THE INVENTION

The present invention will now be described in more detail by way of example with reference to the embodiments shown in the accompanying figures. It should be kept in mind that the following described embodiments are only presented by way of example and should not be construed as limiting the inventive concept to any particular physical configuration, material or order.

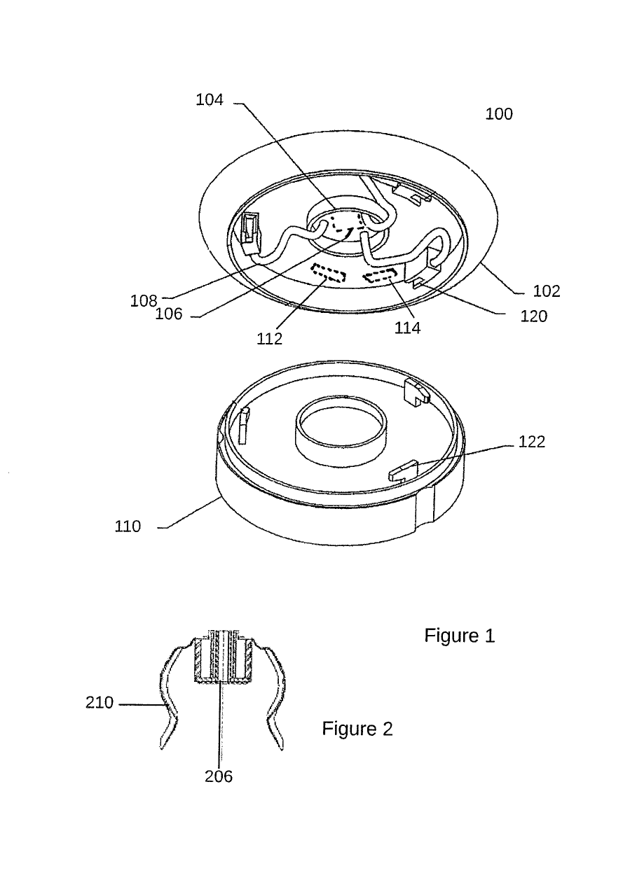

FIG. 1 shows the basic unit 100 in a perspective view which is to be mounted over an electrical box (not shown) in the ceiling. An additional optional embodiment allows for the basic unit 100 to be flush-mounted into an electrical box in the ceiling. Wire(s) 108 coming out of the electrical box (not shown) are connected to their respective at least three female connector(s) 120. The basic unit 100 comprises a top unit 102 which has a center opening 104. Wires 108 are commonly colored white, red and black for easy identification, however, any functionally compatible color and/or color combination may be used.

Furthermore, FIG. 1 further illustrates a battery quick connect 106 located within center opening 104. As illustrated in FIG. 1, battery quick connect 106 operates to lock a battery (not shown) into base unit 100 when the battery is pushed into battery quick connect 106 by a push. For illustrative purposes, the push can be by a human digit, for example, a hand and/or finger, or can be made by a natural and/or artificial device, such as a pole or other mechanism which may provide a push.

FIG. 1 also illustrates a bottom unit 110 which is removably attachable to top unit 102 via at least three male connector(s) 122, using, for example a hand manipulated pole. Additional embodiments of bottom unit contemplate removable attachability via additional mechanisms, such as a human hand or other manipulating device. Yet still further embodiments contemplate a single base unit 100 wherein top unit 102 and bottom unit 110 are a single, non-separable element.

FIG. 1 also illustrates an at least one detector 112 for detecting a prescribed condition in an airstream. Detector 112 can be, as illustrated, connected to the basic wiring 108, however, additional embodiments are contemplated where detector 112 need not require electrical connection to operate in such a manner so as to determine a condition in the air.

Airstream conditions, as contemplated for detection by detector 112, may be, for example, smoke, condensation, high concentrations of carbon monoxide, high concentrations of carbon dioxide, and the like.

FIG. 1 further illustrates an at least one alarm 114 for projecting a sound when detector 112 detects the prescribed condition in the airstream. Alarm 114 can be, as illustrated, connected to the basic wiring 108, however, additional embodiments are contemplated where alarm 114 need not require electrical connection to operate in such a manner so as to emit a sound upon detection of a condition in the air.

Additional embodiments of alarm 114 may include, but are not limited to, flashing lights, energy pulses, vibration, or any other projection which may alert a human or animal as to a condition in the air.

When the battery (not shown) is locked into said battery quick connect 106 via a push, the battery provides a power source for the basic wiring. When the battery disengages from the battery quick connect 106 via another or second push for removal of the battery, the removal terminates of the power source for the basic wiring.

Additional embodiments contemplated but not illustrated in FIG. 1, include but are not limited to a hand manipulated pole (not shown) which may have an upper end with a cap having outwardly extending prongs where these prongs engage at least one peripheral depression on said bottom unit 110. Also contemplated is where bottom unit 110 may optionally have male connectors 122 which engage female connectors 120 by way of rotation of said bottom unit 110.

FIG. 2 illustrates a battery quick connect 206 with a snap 210 which when a battery (not shown) is pushed into battery quick connect 206 and locked into snap 201 a contact between two contact strips—one on the battery and one on basic wiring (not shown), which begin a flow of electricity, powered from the battery. The battery can be are connected in such a way that electricity (flow of electrons) runs between the positive and negative electrodes of the battery.

The battery can rest atop a small spring that is connected to a contact strip (not shown). The contact strip runs down the length of the battery case and makes contact with one side of the switch. There can be another flat contact strip on the other side of the quick connect 206 and snap 210, which runs to the basic wiring, providing an electrical connection, thus completing the circuit between the battery and the basic wiring and completing the generation of electricity.

Additional embodiments contemplated for battery quick connect 206, which include but are not limited to, battery quick connect 206 having at least one flange which acts as a fastener to immobilize the battery when a first push forces the battery into battery quick connect 206, and acts as a release when a second push disengages the battery from said battery quick connect.

Yet still another embodiment contemplated for battery quick connect 206 includes battery quick connect 206 having more than one flange which act as a fastener to immobilize the battery when a first push forces the battery into said battery quick connect 206, and act as a release when a second push disengages the battery from said battery quick connect 206.

Yet a further embodiment for battery quick connect 206 contemplates battery quick connect 206 being connected to an external wiring configuration which attaches fire and smoke detector and alarm device to a general wiring of a structure, for example, such as a residential dwelling, in which the surface into which the base unit is recess-mounted. In this exemplary embodiment, the external wiring configuration allows for a backup power source for the fire and smoke detector and alarm device.

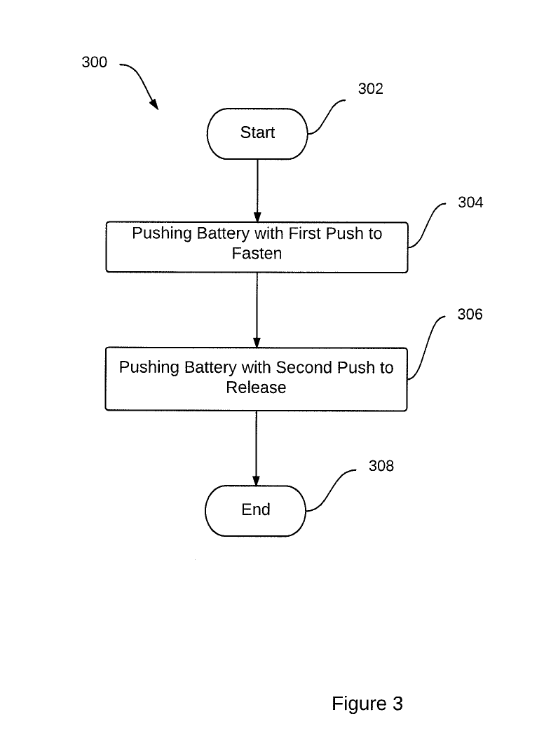

FIG. 3 illustrates a method 300 of inserting and removing a battery into a battery quick connect of a fire and smoke detector and alarm device. Method 300 starts at 302, and at 304 a user pushes a battery with a first push into the exposed at least one flange or snap of a battery quick connect where the flange or snap acts as a fastener to immobilize the battery in the battery quick connect.

At 306, a user pushes a battery with a second push into the flange or snap of the battery quick connect, and then flange or snap acts as a release when the second push disengages the battery from the battery quick connect. The method thereafter ends at 308.

In this exemplary method embodiment, immobilization of the battery in the battery quick connect results in connection with a basic wiring configuration and provides a power source for said basic wiring and wherein release of the battery from the quick connect results in removal of the connection with the basic wiring connection and termination of the power source for said basic wiring.

An additional embodiment of the method 300 as illustrated in FIG. 3 contemplate battery quick connect having more than one flange or snap which acts as a fastener to immobilize the battery when a first push forces the battery into the battery quick connect, and acts as a release when a second push disengages the battery from the battery quick connect.

Yet another exemplary embodiment of the method 300 illustrated in FIG. 3 contemplates the battery quick connect being connected to an external wiring configuration which attaches the fire and smoke detector and alarm device to a general wiring of a structure, for example, such as a residential or commercial residence or dwelling, in which the surface into which the base unit is recess-mounted. In this exemplary embodiment, the external wiring configuration allows for a backup power source for the fire and smoke detector and alarm device.

Yet still a further exemplary embodiment of the method 300 illustrated in FIG. 3 contemplates each element of the fire and smoke detector and alarm device being serviced by maintaining each element, repairing each element, replacing each element or modifying each element in whole or in part.

Additional methods, aspects and elements of the present inventive concept are contemplated in use in conjunction with individually or in any combination thereof which will create a reasonably functioning serving apparatus. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

What I claim is:

1. A fire and smoke detector and alarm device, comprising:
a base unit which is recess-mounted into a surface, said base unit having at least three female connectors connected with a basic wiring attached to each of said female connectors;
a battery quick connect, said battery quick connect locking a battery into the base unit when the battery is pushed into said battery quick connect by a first push;
a bottom unit which is removably attached to the base unit using a hand manipulated pole;
at least one detector for detecting a prescribed condition in an airstream, said at least one detector is connected to the basic wiring; and
at least one alarm for projecting a sound when the at least one detector detects the prescribed condition in the airstream, said at least one alarm is connected to the basic wiring;
wherein when the battery is locked into said battery quick connect via a first push, said battery provides a power source for the basic wiring; the battery disengages from the battery quick connect via a second push for removal of the battery, said removal terminates of the power source for the basic wiring.

2. The fire and smoke detector and alarm device of claim 1, wherein the hand manipulated pole has an upper end with a cap having outwardly extending prongs thereon and said prongs engage at least one peripheral depression on said base unit.

3. The fire and smoke detector and alarm device of claim 1, wherein said bottom unit has male connectors thereon which engage said female connectors by way of rotation of said bottom unit.

4. The fire and smoke detector and alarm device of claim 1, wherein the battery quick connect has at least one flange which acts as a fastener to immobilize the battery when a first push forces the battery into said battery quick connect, and acts as a release when a second push disengages the battery from said battery quick connect.

5. The fire and smoke detector and alarm device of claim 1, wherein the battery quick connect has more than one flange which acts as a fastener to immobilize the battery when a first push forces the battery into said battery quick connect, and acts as a release when a second push disengages the battery from said battery quick connect.

6. The fire and smoke detector and alarm device of claim 1, wherein the battery quick connect is connected an external wiring configuration which attaches said fire and smoke detector and alarm device to a general wiring of a structure in which the surface into which the base unit is recess-mounted, wherein said external wiring configuration allows for a backup power source for said fire and smoke detector and alarm device.

7. A method of inserting and removing a battery into a battery quick connect of a fire and smoke detector and alarm device, comprising:
pushing a battery with a first push into the exposed at least one flange of a battery quick connect, said at least one flange acts as a fastener to immobilize the battery in said battery quick connect; and
pushing a battery with a second push into the exposed at least one flange of the battery quick connect, said at least one flange acts as a release when the second push disengages the battery from said battery quick connect;
wherein immobilization of the battery in the battery quick connect results in connection with a basic wiring configuration and provides a power source for said basic wiring and wherein release of the battery from the quick connect results in removal of the connection with the basic wiring connection and termination of the power source for said basic wiring.

8. The method of claim 7, wherein the battery quick connect has more than one flange which acts as a fastener to immobilize the battery when a first push forces the battery into said battery quick connect, and acts as a release when a second push disengages the battery from said battery quick connect.

9. The method of claim 7, wherein the battery quick connect is connected an external wiring configuration which attaches said fire and smoke detector and alarm device to a general wiring of a structure in which the surface into which the base unit is recess-mounted, wherein said external wiring configuration allows for a backup power source for said fire and smoke detector and alarm device.

10. The method of claim 7, wherein each element of said fire and smoke detector and alarm device is serviced by maintaining each element, repairing each element, replacing each element or modifying each element in whole or in part.
